(19) United States
(12) Patent Application Publication
(10) Pub. No.: US 2007/0201826 A1
(43) Pub. Date: Aug. 30, 2007

(54) Broadcast recording apparatus and broadcast recording method

(76) Inventor: Takahiro Kimura, Fukaya-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/705,100

(22) Filed: Feb. 12, 2007

(30) Foreign Application Priority Data
Feb. 20, 2006 (JP) 2006-043204

(51) Int. Cl. H04N 5/91

(52) U.S. Cl. 386/83

(57) ABSTRACT

According to one embodiment, a broadcast recording apparatus includes a tuner unit that receives a broadcast signal, demodulates the received signal, and outputs a program signal of a program, a recording unit that records the program signal outputted by the tuner unit, a reservation setting unit that sets reservation information on image recording reservation of a program series to execute image recording by the tuner unit and the recording unit, and a continuous reservation program display unit that generates a screen for displaying a plurality of daily image recording schedule information according to reservation information on the continuous program.

### CROSS-REFERENCE TO RELATED APPLICATIONS

This application is based upon and claims the benefit of priority from Japanese Patent Application No. 2006-043204, filed Feb. 20, 2006, the entire contents of which are incorporated herein by reference.

### BACKGROUND

1. Field

One embodiment of the invention relates to a broadcast recording apparatus for recording broadcast program information, and particularly to a broadcast recording apparatus and a broadcast recording method capable of easily making image recording reservation of a next program.

2. Description of the Related Art

Recently, with prevalence of a digital device, a broadcast receiving device such as a hard disk recorder has been generally known, making it possible to record/reproduce a plenty of video image information more easily than a case of a recording/reproducing processing operation using a conventional video tape recorder (VTR). In such a broadcast receiving device, it becomes possible to further facilitate an unattended image recording processing operation by utilizing electronic program information (Electronic Program Guide) supplied from a broadcast channel or a server. Therefore, reservation image recording becomes facilitated, and a plenty of contrivances for image recording reservation has been made.

Here, patent document 1 (Jpn. Pat. Appln. KOKAI Publication No. 2003-169264), patent document 2 (Jpn. Pat. Appln. KOKAI Publication No. 9-180292), and patent document 3 (Jpn. Pat. Appln. KOKAI Publication No. 2005-142761) each disclose an information recording apparatus for notifying a case where duplicate reservations have been made.

However, in the conventional techniques of the patent documents 1 to 3 described above, even if only one item of reservation information on series of five days, for example, has been duplicated with another item of reservation information with respect to reservation information on program series, a display is made as if the entirety were duplicated. Thus, there is a problem that reservation information of all of program series must be released in order to release this duplication.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram depicting an example of a configuration of a broadcast recording apparatus according to an embodiment of the present invention;

FIG. 2 is an illustrative view showing an example of a reservation list in the broadcast recording apparatus;

FIG. 3 is an illustrative view showing an example of an operating screen for checking and clearing contents of reservation in the broadcast recording apparatus;

FIG. 4 is an illustrative view showing an example of a screen for checking a drama series program in the broadcast recording apparatus;

FIG. 5 is an illustrative view showing an example of update history of drama series reservation list in the broadcast recording apparatus;

FIG. 6 is an illustrative view showing an example of a screen for checking a drama series reservation program in the broadcast recording apparatus; and

FIG. 7 is an illustrative view showing an example of a display in the case where reservation in the broadcast recording apparatus cannot be executed.

### DETAILED DESCRIPTION

Various embodiments according to the invention will be described hereinafter with reference to the accompanying drawings. In general, according to one embodiment of the invention, a broadcast recording apparatus, comprising: a tuner unit which receives a broadcast signal, demodulates the received signal, and outputs a program signal of a program; a recording unit which records the program signal outputted by the tuner unit; a reservation setting unit which sets reservation information on image recording reservation of a program series to execute image recording by the tuner unit and the recording unit; and a continuous reservation program display unit which generates a screen for displaying a plurality of daily image recording schedule information according to reservation information on the continuous program.

According to one embodiment of the present invention, there is provided a broadcast recording apparatus, comprising: a tuner unit which receives a broadcast signal, demodulates the received signal, and outputs a program signal of a program; a recording unit which records the program signal outputted by the tuner unit; a reservation setting unit which sets reservation information on image recording reservation of a program series to execute image recording by the tuner unit and the recording unit; and a continuous reservation program display unit which generates a screen for displaying a plurality of daily image recording schedule information according to reservation information on the continuous program.

There is provided a broadcast recording apparatus and a broadcast recording method capable of displaying in listings a schedule of executing reservations on a daily basis with respect to reservation information on program series.

Hereinafter, embodiments of the present invention will be described with reference to the accompanying drawings.

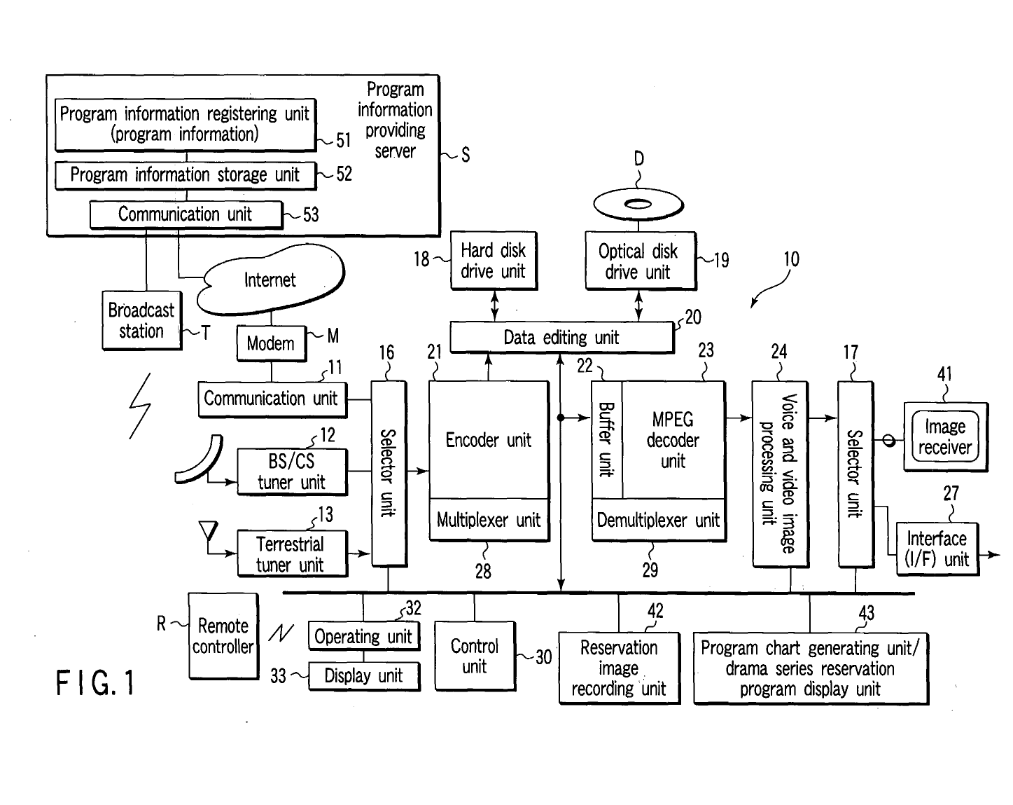

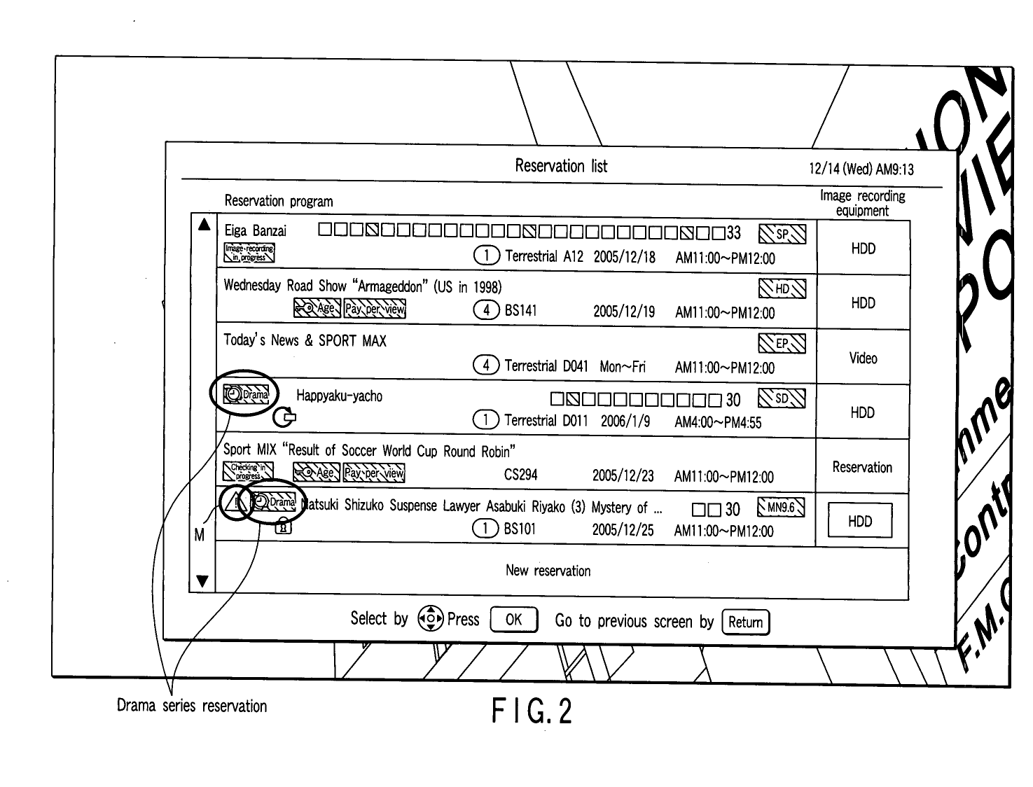

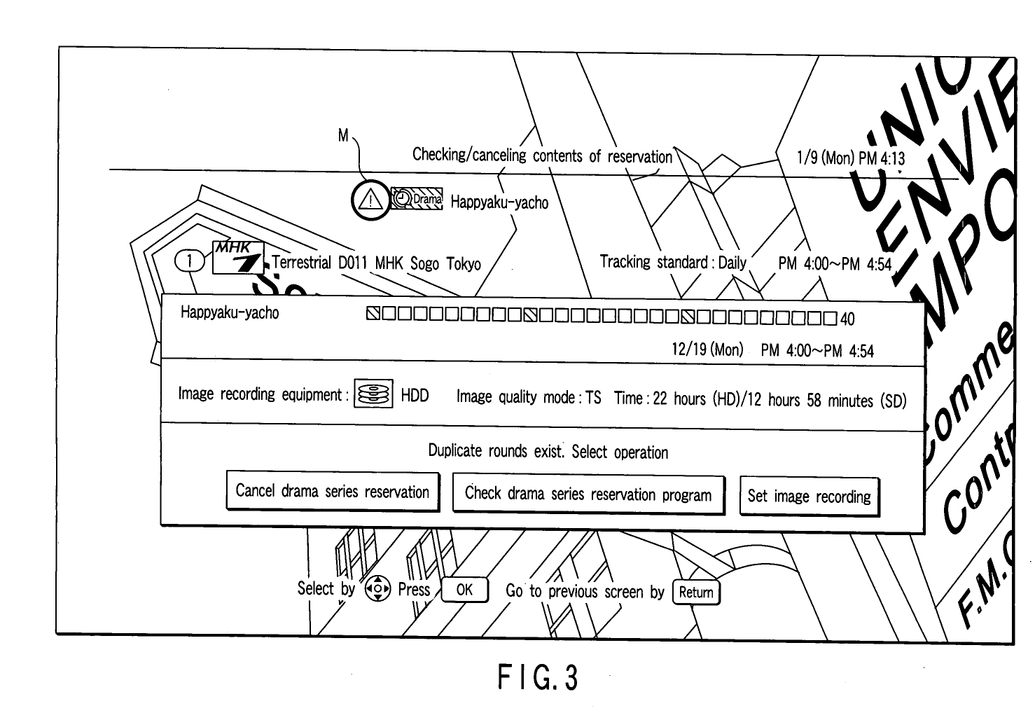

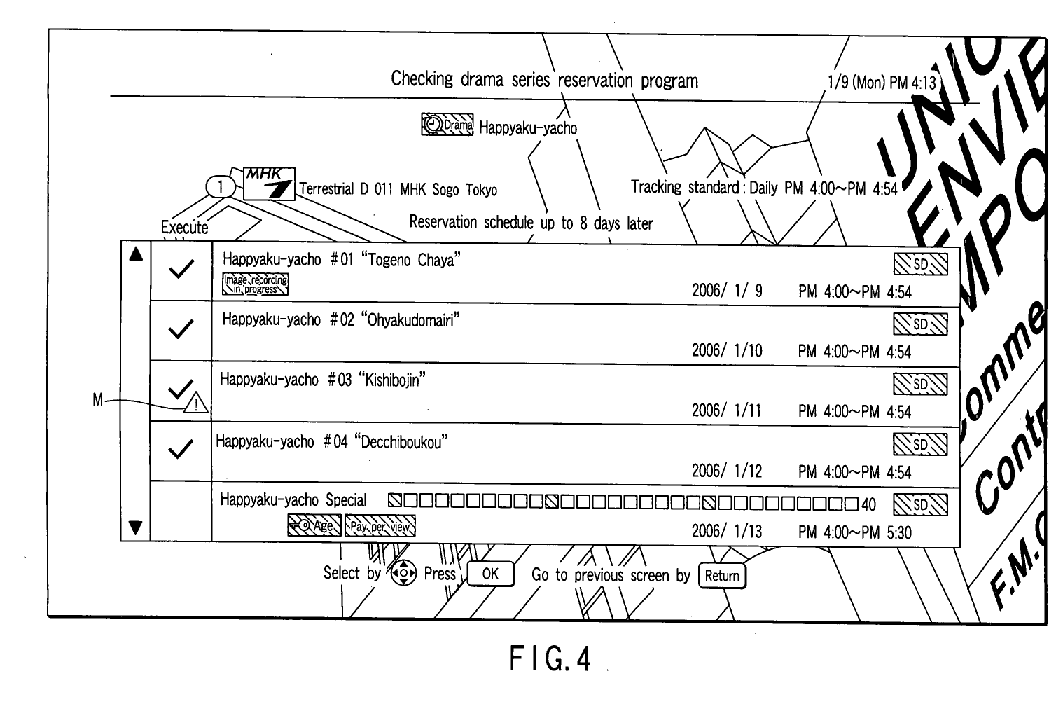

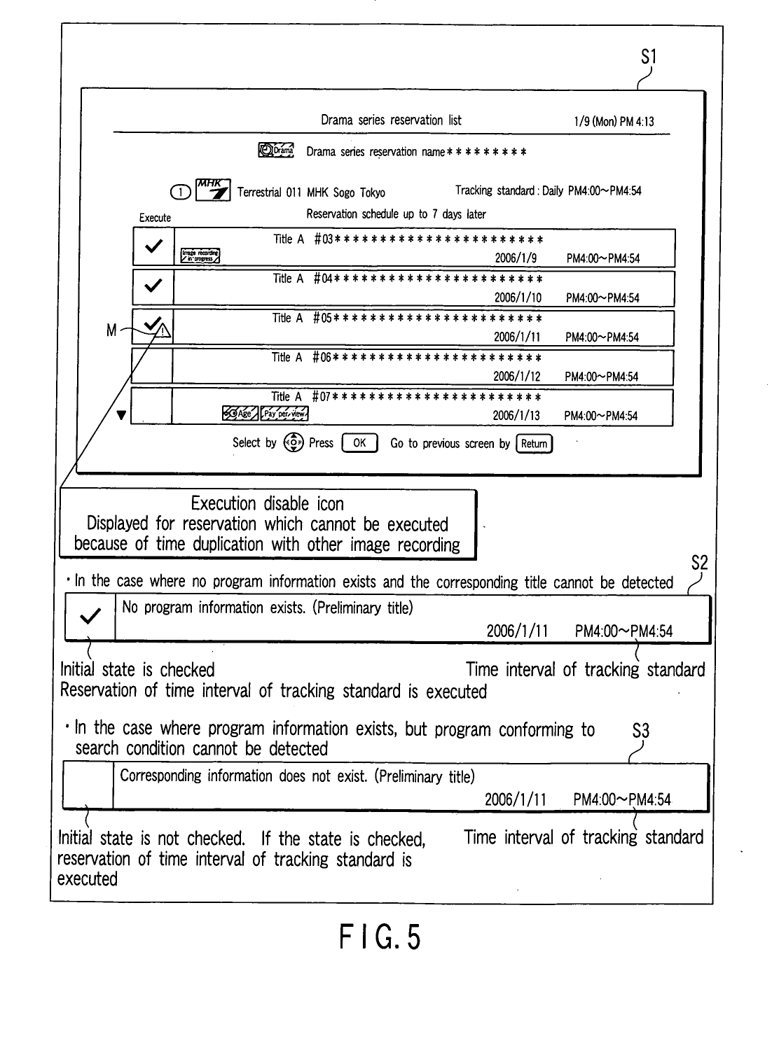

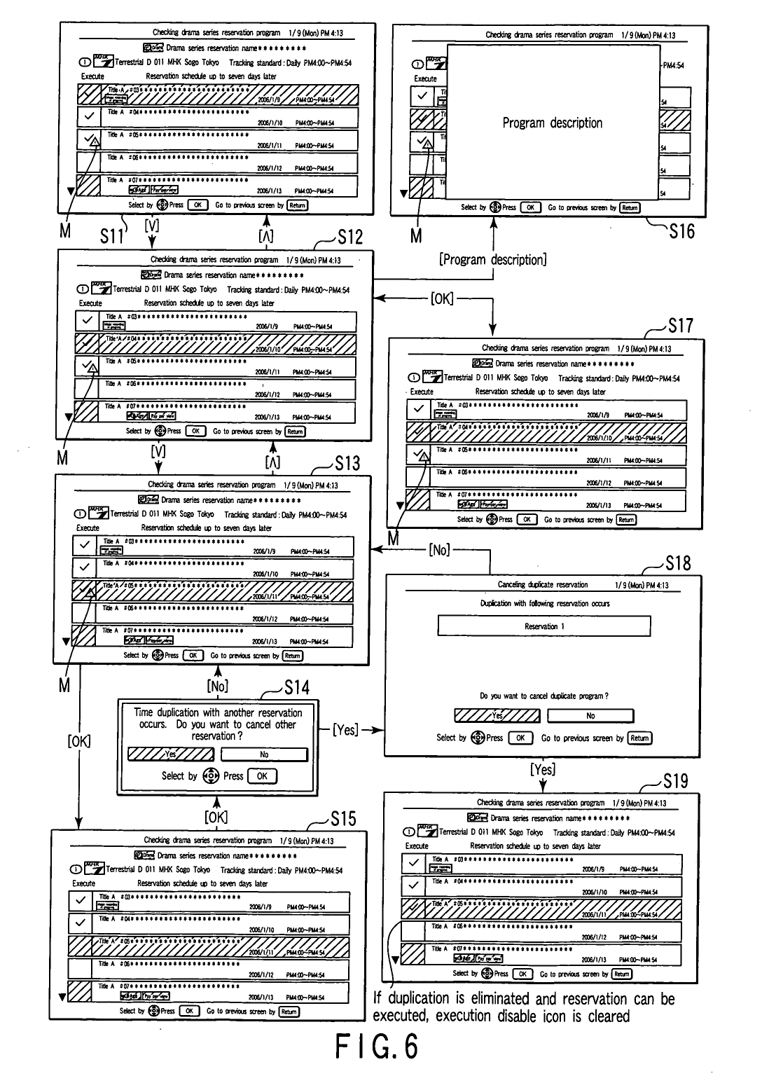

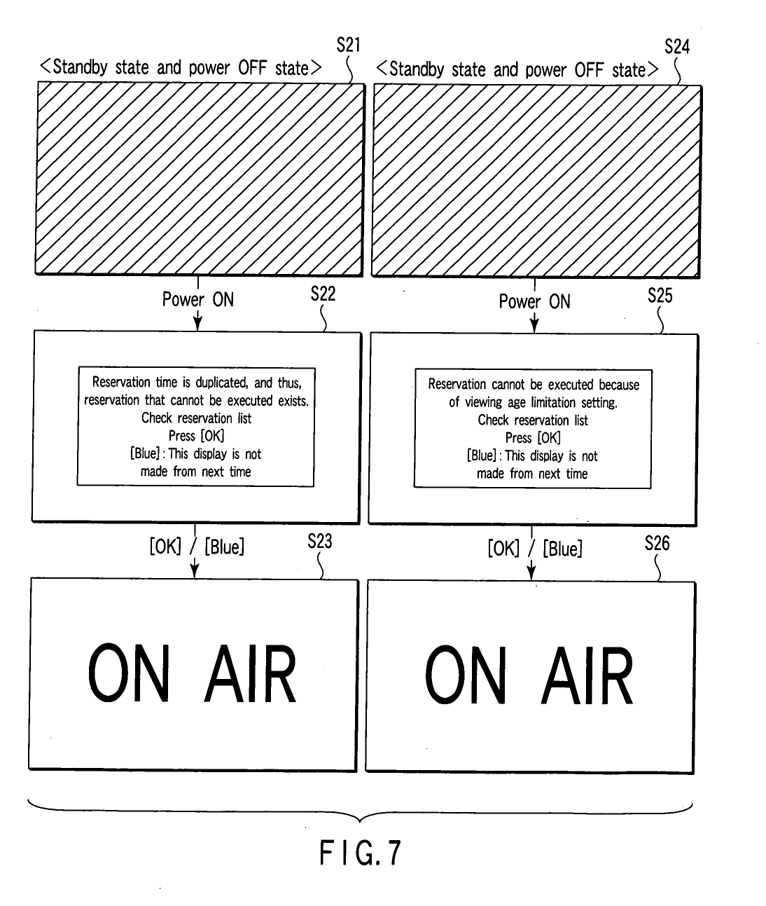

FIG. 1 is a block diagram depicting an example of a configuration of a broadcast recording apparatus according to an embodiment of the present invention; FIG. 2 is an illustrative view showing an example of a reservation list in the broadcast recording apparatus; FIG. 3 is an illustrative view showing an example of an operating screen for checking and clearing contents of reservation in the broadcast recording apparatus; FIG. 4 is an illustrative view showing an example of a screen for checking a drama series program in the broadcast recording apparatus; FIG. 5 is an illustrative view showing an example of update history of drama series reservation list in the broadcast recording apparatus; FIG. 6 is an illustrative view showing an example of a screen for checking a drama series reservation program in the broadcast recording apparatus; and FIG. 7 is an illustrative view showing an example of a display in the case where reservation in the broadcast recording apparatus cannot be executed.

### BROADCAST RECORDING APPARATUS ACCORDING TO AN EMBODIMENT OF THE PRESENT INVENTION

(Configuration)

First, a broadcast receiving apparatus 10 shown in FIG. 1 is provided as an example of a digital television having a recording function while a tuner or the like is used as a source. In addition, it is preferable that the broadcast receiving apparatus 10 be a hard disk recorder having a tuner or the like and a recording function.

Therefore, while the following embodiments with reference to FIG. 1 will describe in detail a digital television having a recording function, it is possible to construe the embodiments as an explanation of a hard disk recorder having completely identical capabilities by separating an image receiver 41 from the constituent elements shown in FIG. 1.

In FIG. 1, the broadcast receiving apparatus 10 serving as a digital television has two types of disk drives. First, this apparatus has a hard disk drive unit 18 for driving a hard disk H as a first medium. Secondly, this apparatus has an optical disk drive unit 19 for rotationally driving an optical disk D as a second medium that is an information recording medium capable of constructing a video file, and then, executing information read and write operations. In addition, a control unit 30 is connected to each unit via a data bus B to control a whole operation. However, in the case of carrying out the present invention, the optical disk drive unit 19 is not always a required constituent element.

In addition, the broadcast receiving apparatus 10 shown in FIG. 1 primarily comprises: an encoder unit 21 that configures an image recording side; an MPEG decoder unit 23 that configures a reproduction side; and a control unit 30 that controls an operation of an apparatus main body. The broadcast receiving apparatus 10 has an input side selector 16 and an output side selector 17. A communication unit 11 such as a LAN, a so called satellite broadcast (BS/CS) digital tuner unit 12, and a so called terrestrial digital/analog tuner unit 13 are connected to the input side selector 16, thereby outputting a signal to the encoder unit 21. In addition, a satellite antenna is connected to the BS/CS digital tuner unit 12 and a terrestrial antenna is connected to the terrestrial digital/analog tuner unit 13. In addition, the broadcast receiving apparatus 10 has: an encoder unit 21; a signal editing unit 20 for receiving an output from the encoder unit 21, and then, carrying out desired data processing such as data editing; a hard disk drive unit 18 connected to the signal editing unit 20; and the optical disk drive unit 19. Further, the broadcast recording apparatus 10 has: a hard disk drive unit 18; an MPEG decoder unit 23 for receiving and decoding a signal from the optical disk drive unit 19; an encoder unit 21; a buffer unit 22; an MPEG decoder unit 23; a multiplexer unit 28; a demultiplexer unit 29; a control unit 30; a reservation image recording unit 42; and a program chart generating unit 43. These units each are connected to the control unit 30 via the data bus B. Further, an output from the selector unit 17 is supplied to an image receiver 41 or is supplied to an external device via an interface unit 27 for making communication with the external device.

Further, the broadcast receiving apparatus 10 has an operating unit 32 connected to the control unit 30 via the data bus B and receiving a user operation or an operation of a remote controller R. Here, the remote controller R shown in FIG. 7 enables operations that are substantially identical to those of the operating unit 32 provided at a main body of the broadcast receiving apparatus 10. This remote controller enables a variety of settings such as supply of a recording or reproducing command for the hard disk drive unit 18 or the optical disk drive unit 19, supply of an edit command, a tuner operation, reservation image recording setting and the like.

Further, a drama series reservation key Y according to an embodiment of the present invention is provided. The drama series reservation key Y may not always be thus named. For example, this key may be a next program reservation key Y or a program series reservation key Y. It is preferable that this key be an operating key that enables reservation of a next program or program series immediately.

(Program Information Providing Server)

Furthermore, a description will be given with respect to a program information providing server S that provides program information to the broadcast receiving apparatus 10 via the communication unit 11 or the like. The program information providing server S has: a program information registering unit 51 that inputs program information including program identification information for identifying a broadcast program name, program broadcast time information corresponding to this program identification information (including, for example, broadcast start time and broadcast time or free program information and the like); a program information storage unit 52 that stores the program information inputted at the program information registering unit 51; and a communication unit 53 that transmits the information stored in the program information storage unit 52 to a desired terminal via a network or the like.

The program information providing server S having such a configuration is provided as a facility of an organization that provides service, in general, and program information including broadcast programs, program identification information on the broadcast programs, and broadcast time information is uploaded in advance. Then, if a change occurs in this program information, changed information is inputted by means of the program information registering unit 51 immediately, thereby carrying out an update processing operation of the program information storage unit 52. At this time, in the case where program information has been inputted, the program information having program identification information that is identical to program information already maintained in the program information providing server S, the program information providing server S replaces the program information maintained in the program information storage unit 52 with the latest information.

The program information providing server S provides program information to a broadcast station T via the communication unit 53, for example, through the Internet via a modem M as shown in FIG. 1, and then, provides program information or the like to the broadcast receiving apparatus 10 in a superimposed manner on a broadcast signal of the broadcast station T (terrestrial digital, terrestrial analog, satellite broadcast digital, satellite broadcast analog or the like).

(Basic Operation)

-Reproduction of Broadcast Contents

In the broadcast receiving apparatus 10 serving as the thus configured digital television, in accordance with an operating signal responsive to an operation of a user's remote controller R or the operating unit 32, a broadcast signal is received, and then, the broadcast contents from the BS/CS tuner unit 12 or the terrestrial digital/analog tuner unit 13 are displayed on the image receiver 41, under the control of the control unit 30 or the like.

-Recording Processing Operation

Now, an operation at the time of recording including those according to other embodiments will be described in detail. As an input side of the broadcast receiving apparatus 10, a communication unit 11 such as a LAN is connected to an external device, thereby making communication with a program information providing server or the like through a communication channel such as the Internet via a modem or the like, or downloading broadcast contents or the like. In addition, the BS/CS digital tuner unit 12 and the terrestrial digital/analog tuner unit 13 select a broadcast signal as a channel and demodulate it via an antenna, and input a video image signal and a voice signal. These tuner units cover diversified types of broadcast signals. For example, the tuner units cover a terrestrial analog broadcast, a terrestrial digital broadcast, a BS analog broadcast, a BS digital broadcast, a CS digital broadcast and the like without being limited thereto. In addition, there is not necessarily provided only one tuner unit. For example, two or three tuner units such as a terrestrial broadcast tuner unit and a BS/CS tuner unit may be provided to function in parallel to each other in response to a request for reservation image recording.

The previously described communication unit 11 may be an IEEE1394 interface and is capable of receiving digital contents from an external device over a network. In addition, it is also possible to receive a luminance signal, a color difference signal, a video image signal such as a composite signal, and a voice signal from an input terminal (not shown). These signals are selectively supplied to the encoder unit 21 by means of the selector 16 controlled by the control unit 30 or the like while inputs are controlled.

The encoder unit 21 has: a video use and an audio use analog/digital converter for digitizing an analog video signal or an analog audio signal inputted by means of the selector 16; a video encoder, and an audio encoder. For example, a subsidiary video image encoder is also included. An output from the encoder 21 is converted into a compression format such as predetermined MPEG, and the converted output is supplied to the previously described control unit 30.

In addition, the BS/CS digital tuner 12 or the like is not always incorporated. Preferably, this tuner is externally provided via a data input terminal to supply the received digital signal to the encoder unit 21 or the control unit 30 via the selector unit 16.

Here, the apparatus shown in FIG. 1 supplies information (pack such as video, audio, and subsidiary video image data) encoded by the encoder unit 21 and produced management information to the hard disk drive unit 18 or the optical disk drive unit 19 via the control unit 30 so that the supplied items of information can be recorded in the hard disk drive unit 18 or the optical disk D. In addition, the information recorded in the hard disk drive unit 18 or the optical disk D can also be recorded in the optical disk D or the hard disk drive unit 18 via the control unit 30 or the optical disk drive unit 19.

The signal editing unit 20 is capable of making an edit processing operation such as partially deleting video objects of a plurality of programs recorded in the hard disk drive unit 18 or the optical disk D or connecting objects of different programs with each other.

-Reproducing Processing Operation or the Like

Now a processing operation of reproducing recorded information including those according to other embodiments will mainly be described in detail. The MPEG decoder unit 23 comprises a video processor for properly combining a decoded subsidiary video image with a decoded main video image, and then, superimposing a menu, a highlight button, subtitles or any other subsidiary video image on a main video image to be outputted.

An output audio signal of the MPEG decoder unit 23 is supplied to a speaker after being analog-converted by means of a digital/analog converter (not shown), via the selector unit 17 or is supplied to an external device via the I/F 27. The selector unit 17 is controlled by a select signal from the control unit 30. In this manner, the selector unit 17 can directly select a signal having passed through the encoder unit 21 when a digital signal from each of the tuner units 12 and 13 is directly monitored.

-Reservation Image Recording Processing Operation

In addition, based on electronic program information acquired from the communication unit 11 or the tuners 12 and 13, an image recording reservation processing operation can be made by means of the reservation image recording unit (program chart generating unit) 43 in response to a program specified by an operation of a user's remote controller R or the like. At the same time, it is possible to display on a screen a program chart based on the acquired electronic program information. Further, based on the reserved reservation image recording information and by working of the control unit 30 and the reservation image recording unit 43, when a reservation time has come, video image and voice signals produced when the program information received by the BS/CS digital tuner unit 12 or the terrestrial digital/analog tuner unit 13 is demodulated is recorded (reserved and recorded as images) in the hard disk drive unit 18, for example, through an encode processing operation of the encoder 21 or the like.

The broadcast receiving apparatus 10 according to the present embodiment has the thus comprehensive functions and carries out a recording/reproducing processing operation by an optical disk D or the hard disk drive unit 18 with respect to a plurality of sources.

### DRAMA SERIES RESERVATION PROGRAM DISPLAY PROCESSING OPERATION ACCORDING TO AN EMBODIMENT OF THE PRESENT INVENTION

Now, a drama series reservation program display processing operation according to an embodiment of the present invention will be described below in detail with reference to illustrative views of FIGS. 2 to 4, flow charts of FIGS. 5 and 6, and an illustrative view of FIG. 7.

A current broadcast receiver incorporates a storage function, comprises a program signal image recording/reproducing function, and incorporates a daily reservation function of continuously reserving a series of periodically broadcasted programs by single reservation setting. Further, the daily reservation functions in recent years include a function of executing reservation in accordance with a changed broadcast time by utilizing program information (for example, detecting a desired program in titles, broadcast time intervals or the like) in the case where a broadcast time of a reserved program has been changed as well as reserving and image-recording a set channel in a set time.

However, in such a daily reservation, there occurs a case in which a desired program cannot be detected or a problem that one reservation cannot be executed when a duplication with a time of another reservation occurs because a reservation time has been changed. Thus, a user's expected reservation may not be executed.

In an embodiment of the present invention, there is provided a function of presenting a user with information on a program reserved and executed, or possibility of executing reservation by displaying a schedule of executing daily reservation in listings.

(Reservation Content Check Processing Operation)

First, in the broadcast receiving apparatus 10 described above, by means of a reservation image recording unit 42, for example, a reservation list as shown in FIG. 2 is generated, and an image recording reservation processing operation is carried out, using an electronic program chart supplied from a program information providing server S. Here, a image recording reservation processing operation using a “drama series mode” is carried out, as in “Happyaku-yacho” in the fourth row from top or the drama series in the sixth row as well as a single image recording reservation.

With respect to the contents of reservation, check of the contents of reservation of drama series mode can be made by using a screen for “checking/canceling contents of reservation” shown in FIG. 3. Here, a judgment is made as to possibility of executing all reservation information based on current reservation information, other reservation information, and electronic program information by working of the reservation image recording unit 42 and a drama series reservation program display unit 43. Then, if a duplicate reservation round occurs, a warning “duplication rounds exist. Select an operation” is displayed on a screen shown in FIG. 3. Further, operations of “canceling drama series reservation”, “checking drama series reservation program”, and “setting image recording” are promoted by displaying icons.

When a user depresses “checking drama series reservation program” by an operation of a remote controller R or the like, a “screen for checking drama series reservation program” as shown in FIG. 4 is displayed. This screen comprehensively displays situations of continuous reservations from January 9 to January 13 in listings.

Here, it is possible to know that only a program of January 11 that is a third day duplicates with another reservation by means of a duplicate mark M (step S1). However, if no program information exists and the corresponding title is not detected, an initial state has been checked, reservation of a time interval of a tracking standard is executed, and then, a message “No program information exists” is displayed (step S2). Further, in the case where program information exists, but a program matching a search condition cannot be detected, an initial state is not checked, reservation of a time interval of a tracking standard is executed if checked, and then, a message “the corresponding information does not exist” is displayed (step S3).

(Reservation Content Check Processing Operation: Drama Series Reservation Program Check Screen)

Now, with reference to FIG. 6, a description will be given with respect to a reservation content check processing operation using a drama series reservation program check screen. In the drama series reservation program check screen, a cursor first specifies reservation information on a first line (step S11). Next, when the cursor is moved to a second line (step S12), and then, a program description is specified, program description information on the specified program is displayed on a screen (step S16). Further, when the cursor is moved to a third line (step S13), a duplicate mark M is displayed, indicating that a duplicate reservation occurs. Thus, a question icon is displayed, indicating that “a time duplication with another reservation occurs. Do you want to cancel such another reservation?” (step S14).

When “Yes” is selected by icon operation using a remote controller R or the like, a “duplicate reservation cancellation screen” indicating the currently duplicated “reservation 1” is displayed (step S18). In this screen, when “Yes” is answered in response to a question “Do you want to cancel a duplicate program?” (step S18), a “drama series reservation program check screen” is displayed (step S19). Then, after duplication has been eliminated, when reservation can be executed, an execution disable icon is cleared.

(Other Display Function)

Another display function according to an embodiment of the present invention will be described here. As shown in FIG. 7, when power is supplied in a standby state or in a power “OFF” state (step S21), a message is displayed, indicating that “reservation cannot be executed because of a duplicate reservation time. Check a reservation list” (step S22). Here, by pressing “OK” or “Blue”, a normal receiving screen is displayed (step S23).

Similarly, as shown in FIG. 7, when power is supplied in a standby state or in a power “OFF” state (step S24), a message is displayed, indicating that “reservation cannot be executed because of viewing age limitation setting. Check a reservation list.” (step 25). Here, by pressing “OK” or “Blue”, a normal receiving screen is displayed (step S26).

As described above, a situation is displayed and described immediately after power has been supplied, making it easy for a user to reliably recognize a current situation of image recording reservation.

(Other Function)

In addition, as shown in a reservation line in a second row of FIG. 2, the drama series reservation program display unit 43 displays a pay per view (PPV) program and a program in which a parental rate is set, and then, makes a display indicating a case where reservation is not executed by current setting.

In addition, when the communication unit 11 cannot detect program information relating to a broadcast signal, it is preferable that the drama series reservation program display unit 43 generate a screen indicating that fact.

In addition, it is preferable that the drama series reservation program display unit 43 make control to record a video image and voice signal of a broadcast signal in a recording unit when a time indicating reservation information has come, or make control to cancel reservation image recording of reservation information in the case where reservation information set by a reservation setting unit is not found from program information acquired by the communication unit.

(Application to Broadcast Receiving Apparatus)

In addition, the processing operations described in these flow charts can be applied not only to the broadcast receiving apparatus 10 described above. For example, these processing operations can be applied similarly in a hard disk recorder or the like serving as the broadcast receiving apparatus 10 having an image recording function.

One skilled in the art can achieve the present embodiments in accordance with a plurality of embodiments described above. Further, a variety of modified examples of these embodiments can be readily conceived by one skilled in the art, thus making it possible to apply to a variety of embodiments even if one does not have any inventive ability. Therefore, the present invention covers a broad scope without departing from the disclosed principle and novel features, and is not limited to the embodiments described above.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A broadcast recording apparatus, comprising:
a tuner unit which receives a broadcast signal, demodulates the received signal, and outputs a program signal of a program;
a recording unit which records the program signal outputted by the tuner unit;
a reservation setting unit which sets reservation information on image recording reservation of a program series to execute image recording by the tuner unit and the recording unit; and
a continuous reservation program display unit which generates a screen for displaying a plurality of daily image recording schedule information according to reservation information on the continuous program.

2. The broadcast recording apparatus according to claim 1, further comprising a communication unit which acquires electronic program information from the broadcast signal,
wherein the continuous reservation program display unit judges and displays possibility of executing reservation for each item of a plurality of daily image recording schedule information contained in the continuous reservation program display unit, based on the electronic program information from the communication unit and another item of reservation information.

3. The broadcast recording apparatus according to claim 1, wherein the continuous reservation program display unit generates a screen to display on the screen a mark indicating the presence of another item of reservation information duplicated with the reservation information.

4. The broadcast recording apparatus according to claim 1, wherein the reservation setting unit sets reservation information on a program series of the broadcast signal.

5. The broadcast recording apparatus according to claim 1, wherein, in the case where reservation information on the set program series is duplicated with another item of reservation, the reservation setting unit deletes only a duplicate portion in the reservation information on the set program series without deleting the reservation information on the set program series.

6. The broadcast recording apparatus according to claim 1, wherein the continuous reservation program display unit makes a display of a PPV program or a program in which a parental rate is set, and makes a display indicating a case where reservation is not executed in current setting.

7. The broadcast recording apparatus according to claim 1, wherein, in the case where the communication unit cannot detect program information relating to the broadcast signal, the continuous reservation program display unit generates a screen for displaying that fact.

8. The broadcast recording apparatus according to claim 1, further comprising a reservation image recording unit that makes control to record in the recording unit a program signal of the broadcast signal when a time indicating the reservation information has come, and makes control to cancel reservation image recording of the reservation information in the case where the reservation information set by the reservation setting unit is not found from the program information acquired by the communication unit.

9. A broadcast recording method, comprising:
setting reservation information on image recording reservation of program series to be reserved by means of a tuner unit that receives a broadcast signal, demodulates the received signal, and outputs a program signal of a program and a recording unit that records the program signal;
acquiring program information relating to the broadcast signal; and
listing in time series a plurality of items of reservation information on the program series, and then, generating a screen for judging and displaying a possibility of executing reservation for each of said plurality of items of reservation information based on the program information and another item of reservation information.

10. The broadcast recording method according to claim 9, comprising:
acquiring electronic program information from the broadcast signal; and
judging and displaying a possibility of executing reservation for each of a plurality of items of daily image recording schedule information on the continuous reservation program display unit, based on the electronic program information and another item of reservation information.

11. The broadcast recording method according to claim 9, wherein a screen is generated to display on the screen a mark indicating the presence of another item of reservation information duplicated with the reservation information.

12. The broadcast recording method according to claim 9, wherein reservation information is set on a program series of the broadcast signal.

13. The broadcast recording method according to claim 9, wherein, in the case where reservation information on the set program series is duplicated with another item of reservation, only a duplicate portion in the reservation information on the set program series is deleted without deleting the reservation information on the set program series.

14. The broadcast recording method according to claim 9, wherein a display is made as to a PPV program or a program in which a parental rate is set, and a display is made, indicating a case where reservation is not executed in current setting.

15. The broadcast recording method according to claim 9, wherein, in the case where the communication unit cannot detect program information relating to the broadcast signal, a screen for displaying that fact is generated.

16. The broadcast recording method according to claim 9, wherein control is made to record in the recording unit a program signal of the broadcast signal when a time indicating the reservation information has come, and control is made to cancel reservation image recording of the reservation information in the case where the reservation information is not found from the program information.
